(19) United States
(12) Patent Application Publication
(10) Pub. No.: US 2026/0197702 A1
(43) Pub. Date: Jul. 9, 2026

(54) UNAVAILABILITY HANDLING IN WLANS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Frisco, TX (US); Vishnu Vardhan Ratnam, Frisco, TX (US); Yue Qi, Plano, TX (US); Bilal Sadiq, Plano, TX (US)

(21) Appl. No.: 19/414,263

(22) Filed: Dec. 9, 2025

Related U.S. Application Data
(60) Provisional application No. 63/743,061, filed on Jan. 8, 2025.
(60) Provisional application No. 63/761,726, filed on Feb. 21, 2025.
(60) Provisional application No. 63/761,737, filed on Feb. 21, 2025.
(60) Provisional application No. 63/761,755, filed on Feb. 21, 2025.
(60) Provisional application No. 63/761,761, filed on Feb. 21, 2025.
(60) Provisional application No. 63/761,765, filed on Feb. 21, 2025.
(60) Provisional application No. 63/913,583, filed on Nov. 7, 2025.

(51) Int. Cl. H04W 28/02

(52) U.S. Cl. CPC H04W 28/0278; H04W 28/0257

(57) ABSTRACT

Methods and apparatuses for unavailability handling. A method of wireless communication performed by a station (STA) includes generating a buffer status report poll (BSRP) frame comprising an indication that the BSRP frame carries unavailability information of the STA; transmitting the BSRP frame to an access point (AP) associated with the STA; and receiving a response frame from the AP based on the indication.

### CROSS-REFERENCE TO RELATED APPLICATION(S) AND CLAIM OF PRIORITY

This application claims priority under 35 U.S.C. § 119 (e) to U.S. Provisional Patent Application No. 63/743,061, filed on Jan. 8, 2025, U.S. Provisional Patent Application No. 63/761,726, filed on Feb. 21, 2025, U.S. Provisional Patent Application No. 63/761,737, filed on Feb. 21, 2025, U.S. Provisional Patent Application No. 63/761,755, filed on Feb. 21, 2025, U.S. Provisional Patent Application No. 63/761,761, filed on Feb. 21, 2025, U.S. Provisional Patent Application No. 63/761,765, filed on Feb. 21, 2025, and U.S. Provisional Patent Application No. 63/913,583, filed on Nov. 7, 2025, each of which are hereby incorporated by reference in their entirety.

### TECHNICAL FIELD

This disclosure relates generally to wireless communication, and more specifically to unavailability handling in Wireless Local Area Networks (WLANs).

### BACKGROUND

Wireless Local Area Network (WLAN) technology allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for procedures for unavailability handling in next generation WLANs.

In one embodiment, a station (STA) comprises a transceiver, and a processor operably coupled with the transceiver. The processor is configured to: generate a buffer status report poll (BSRP) frame comprising an indication that the BSRP frame carries unavailability information of the STA; transmit, via the transceiver, the BSRP frame to an access point (AP) associated with the STA; and receive, via the transceiver, a response frame from the AP based on the indication.

In another embodiment, an AP comprises a transceiver, and a processor operably coupled with the transceiver. The processor is configured to: receive from a STA associated with the AP, via the transceiver, a BSRP frame comprising an indication that the BSRP frame carries unavailability information of the STA; and transmit, via the transceiver, a response frame to the STA based on the indication.

In yet another embodiment, a method of wireless communication performed by a STA includes generating a BSRP frame comprising an indication that the BSRP frame carries unavailability information of the STA; transmitting the BSRP frame to an AP associated with the STA; and receiving a response frame from the AP based on the indication.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example access point (AP) according to embodiments of the present disclosure;

FIG. 3 illustrates an example station (STA) according to embodiments of the present disclosure;

FIG. 4 illustrates an example of a ranging round according to embodiments of the present disclosure;

FIG. 5 illustrates an example of a beacon interval according to embodiments of the present disclosure;

FIG. 6 illustrates an example of a buffer status report poll (BSRP) frame to fetch a buffer status report (BSR) according to embodiments of the present disclosure;

FIG. 7 illustrates an example of a BSRP frame to report unavailability information according to embodiments of the present disclosure;

FIG. 8 illustrates an example scenario that illustrates a lack of time to report an upcoming coexistence/unavailability event according to embodiments of the present disclosure;

FIG. 9 illustrates an example of quality of service (QoS) setup handling under unavailability mode operation according to embodiments of the present disclosure;

FIG. 10 illustrates an example of a procedure for a response indication at the transmitter side according to embodiments of the present disclosure;

FIG. 11 illustrates an example of a procedure for response indication at the receiver side according to embodiments of the present disclosure;

FIG. 12 illustrates example signaling using common field information according to embodiments of the present disclosure;

FIG. 13 illustrates example signaling based on a trigger type subfield according to embodiments of the present disclosure;

FIG. 14 illustrates an example format of a feedback user information field according to embodiments of the present disclosure;

FIG. 15 illustrates an example format of information in the feedback information subfield according to embodiments of the present disclosure;

FIG. 16 illustrates an example of a frame handling procedure according to embodiments of the present disclosure;

FIG. 17 illustrates an example procedure for retry/retransmission counter handling according to embodiments of the present disclosure;

FIG. 18 illustrates an example of a format for a feedback subfield according to embodiments of the present disclosure;

FIG. 19 illustrates an example scenario that illustrates multiple unavailability event reporting according to embodiments of the present disclosure;

FIG. 20 illustrates an example of a format for multiple feedback subfields in the per application ID (AID) traffic identified (TID) information field according to embodiments of the present disclosure;

FIG. 21 illustrates an example procedure of an update of a stream classification service (SCS) agreement according to embodiments of the present disclosure;

FIG. 22 illustrates an example procedure of abiding by the original SCS agreement according to embodiments of the present disclosure;

FIG. 23 illustrates an example procedure for quality of service (QoS) handling according to embodiments of the present disclosure; and

FIG. 24 illustrates an example method performed by a STA in a wireless communication system according to embodiments of the present disclosure.

### DETAILED DESCRIPTION

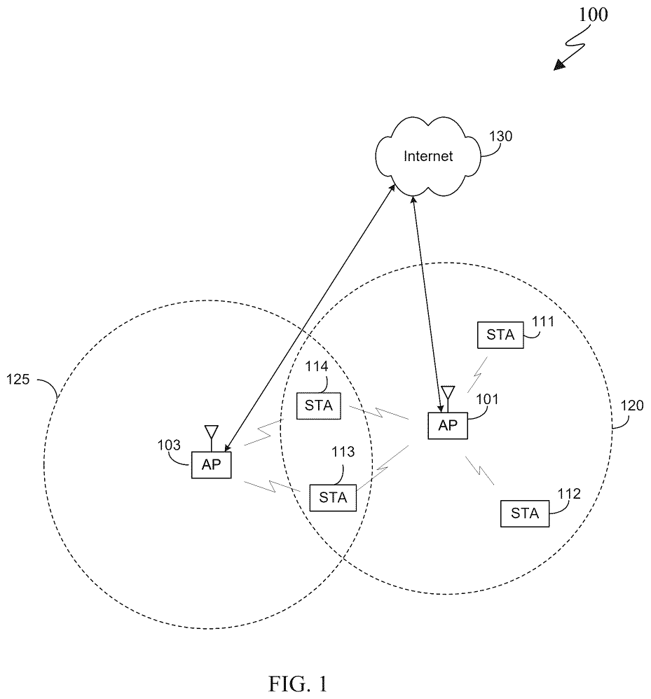

FIGS. 1 through 24, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D2.0, 2022; [2] IEEE Std 802.11-2020.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the APs may include circuitry and/or programming for facilitating procedures for unavailability handling. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

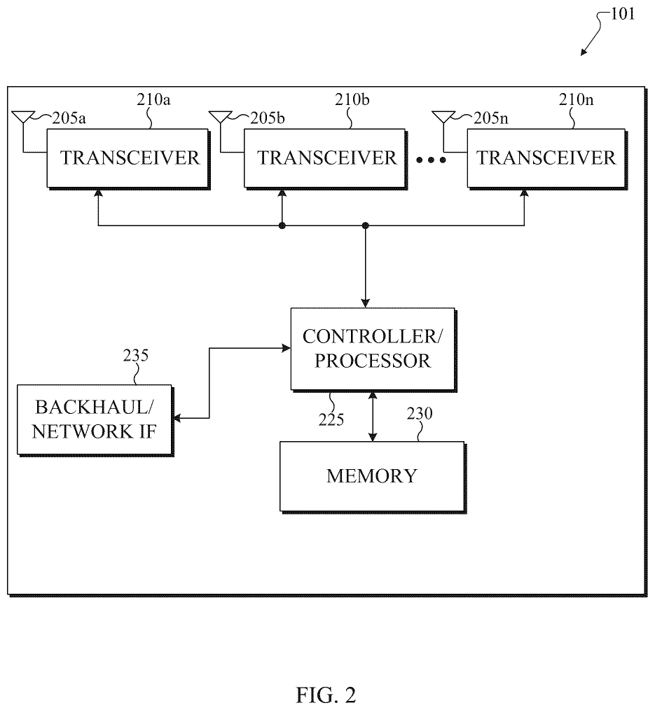

FIG. 2 illustrates an example AP 101 according to various embodiments of the present disclosure. The embodiment of the AP 101 illustrated in FIG. 2 is for illustration only, and the AP 103 of FIG. 1 could have the same or similar configuration. However, APs come in a wide variety of configurations, and FIG. 2 does not limit the scope of this disclosure to any particular implementation of an AP.

The AP 101 includes multiple antennas 205a-205n and multiple transceivers 210a-210n. The AP 101 also includes a controller/processor 225, a memory 230, and a backhaul or network interface 235. The transceivers 210a-210n receive, from the antennas 205a-205n, incoming radio frequency (RF) signals, such as signals transmitted by STAs 111-114 in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the AP 101. For example, the controller/processor 225 could control the reception of forward channel signals and the transmission of reverse channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing signals from multiple antennas 205a-205n are weighted differently to effectively steer the outgoing signals in a desired direction. The controller/processor 225 could also support OFDMA operations in which outgoing signals are assigned to different subsets of subcarriers for different recipients (e.g., different STAs 111-114). Any of a wide variety of other functions could be supported in the AP 101 by the controller/processor 225 including facilitating procedures for unavailability handling. In some embodiments, the controller/processor 225 includes at least one microprocessor or microcontroller. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the AP 101 to communicate with other devices or systems over a backhaul connection or over a network. The interface 235 could support communications over any suitable wired or wireless connection(s). For example, the interface 235 could allow the AP 101 to communicate over a wired or wireless local area network or over a wired or wireless connection to a larger network (such as the Internet). The interface 235 includes any suitable structure supporting communications over a wired or wireless connection, such as an Ethernet or RF transceiver. The memory 230 is coupled to the controller/processor 225. Part of the memory 230 could include a RAM, and another part of the memory 230 could include a Flash memory or other ROM.

As described in more detail below, the AP 101 may include circuitry and/or programming for facilitating procedures for unavailability handling. Although FIG. 2 illustrates one example of AP 101, various changes may be made to FIG. 2. For example, the AP 101 could include any number of each component shown in FIG. 2. As a particular example, an access point could include a number of interfaces 235, and the controller/processor 225 could support routing functions to route data between different network addresses. Alternatively, only one antenna and transceiver path may be included, such as in legacy APs. Also, various components in FIG. 2 could be combined, further subdivided, or omitted, and additional components could be added according to particular needs.

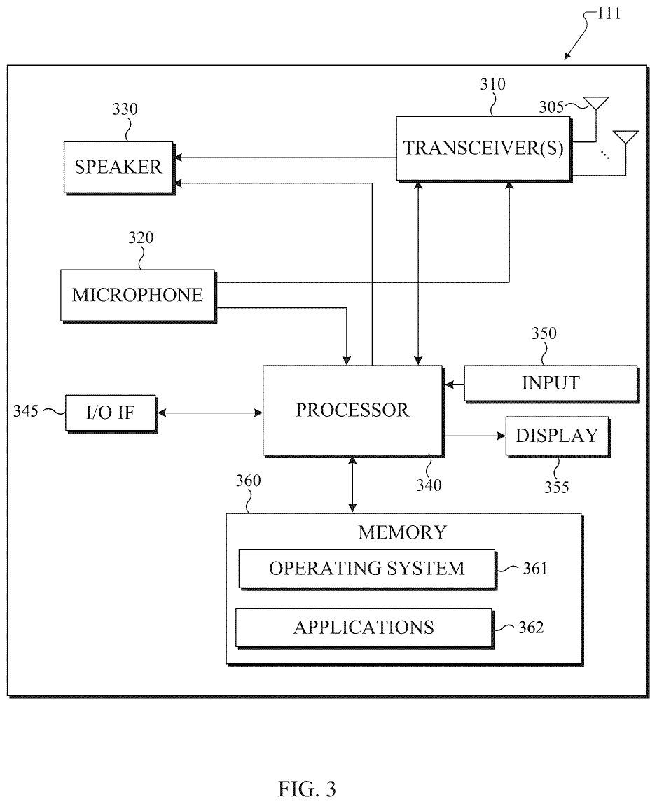

FIG. 3 illustrates an example STA 111 according to various embodiments of the present disclosure. The embodiment of the STA 111 illustrated in FIG. 3 is for illustration only, and the STAs 111-114 of FIG. 1 could have the same or similar configuration. However, STAs come in a wide variety of configurations, and FIG. 3 does not limit the scope of this disclosure to any particular implementation of a STA.

The STA 111 includes antenna(s) 305, transceiver(s) 310, a microphone 320, a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal (e.g., transmitted by an AP 101 of the network 100). The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors and execute the basic OS program 361 stored in the memory 360 in order to control the overall operation of the STA 111. In one such operation, the processor 340 controls the reception of forward channel signals and the transmission of reverse channel signals by the transceiver(s) 310 in accordance with well-known principles. The processor 340 can also include processing circuitry configured to facilitate procedures for unavailability handling. In some embodiments, the processor 340 includes at least one microprocessor or microcontroller.

The processor 340 is also capable of executing other processes and programs resident in the memory 360, such as operations for facilitating procedures for unavailability handling. The processor 340 can move data into or out of the memory 360 as required by an executing process. In some embodiments, the processor 340 is configured to execute a plurality of applications 362, such as applications for facilitating procedures for unavailability handling. The processor 340 can operate the plurality of applications 362 based on the OS program 361 or in response to a signal received from an AP. The processor 340 is also coupled to the I/O interface 345, which provides STA 111 with the ability to connect to other devices such as laptop computers and handheld computers. The I/O interface 345 is the communication path between these accessories and the processor 340.

The processor 340 is also coupled to the input 350, which includes for example, a touchscreen, keypad, etc., and the display 355. The operator of the STA 111 can use the input 350 to enter data into the STA 111. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of STA 111, various changes may be made to FIG. 3. For example, various components in FIG. 3 could be combined, further subdivided, or omitted and additional components could be added according to particular needs. In particular examples, the STA 111 may include any number of antenna(s) 305 for MIMO communication with an AP 101. In another example, the STA 111 may not include voice communication or the processor 340 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

Embodiments of the present disclosure recognize that Wi-Fi devices can have a number of Wi-Fi and non-Wi-Fi radios that can co-exist on the same device. Some non-Wi-Fi technology radios which can co-exist with Wi-Fi are as stated below.

### Bluetooth Operation:

Bluetooth is a wireless technology that started off as a short-distance cable replacement mechanism. Bluetooth classic is used for streaming applications (e.g., headset) operates on 79 RF channels each spaced 1 MHz apart. Bluetooth low energy (BLE) on the other hand is used for IOT applications and operates on 40 RF channels each spaced 2 MHz apart. In the case of Bluetooth, some channels are reserved specifically for the purpose of advertisement and others are used for secondary advertisement for data transmission. In the case of Bluetooth classic, 32 channels are reserved for advertisement whereas in the case of BLE 3 channels are reserved for advertisement.

In Bluetooth transmission happens as a part of a connection event. During a connection event, two devices that are engaged in data transmission alternate sending data until the data to be sent on both sides is exhausted. One of the devices acts as the master and the other device acts as the slave. The master sends a packet to the slave and if the slave receives the packet it sends back a packet to the master. The duration between two connection events is called a connection interval. Connection interval values range from 7.5 ms to 4s. The exact value can be negotiated between the master and the slave to optimize their power saving while balancing latency incurred. Bluetooth transmissions follow a frequency hopping spread spectrum method where a hopping sequence is used to rapidly hop between data channels.

As Bluetooth and Wi-Fi follow different channel access protocols, coexistence of Bluetooth can lead to interference to Wi-Fi transmission. Some Bluetooth transmissions can be scheduled making the interference more predictable. However, in other cases, Bluetooth interference can be hard to predict in advance. Thus, Wi-Fi needs to have mechanisms to react to Bluetooth interference when it occurs in such cases.

Today Bluetooth is used for a large number of applications such as streaming applications, sensor applications, way finding based on beaconing, etc. Wi-Fi routers from a few vendors also come equipped with Bluetooth radios for the purpose of way finding/location awareness applications. Further, an end user's phone can also be configured as a Mobile AP which can also have Bluetooth operating on it.

Bluetooth has primarily operated on 2.4 GHz band. However, in next generation Bluetooth technology, the operation is expected to be extended to 5 GHz and 6 GHz band as well. Thus, the interference problem can be worse for Wi-Fi operation which also uses these bands for communication.

### Ultra-Wideband Operation:

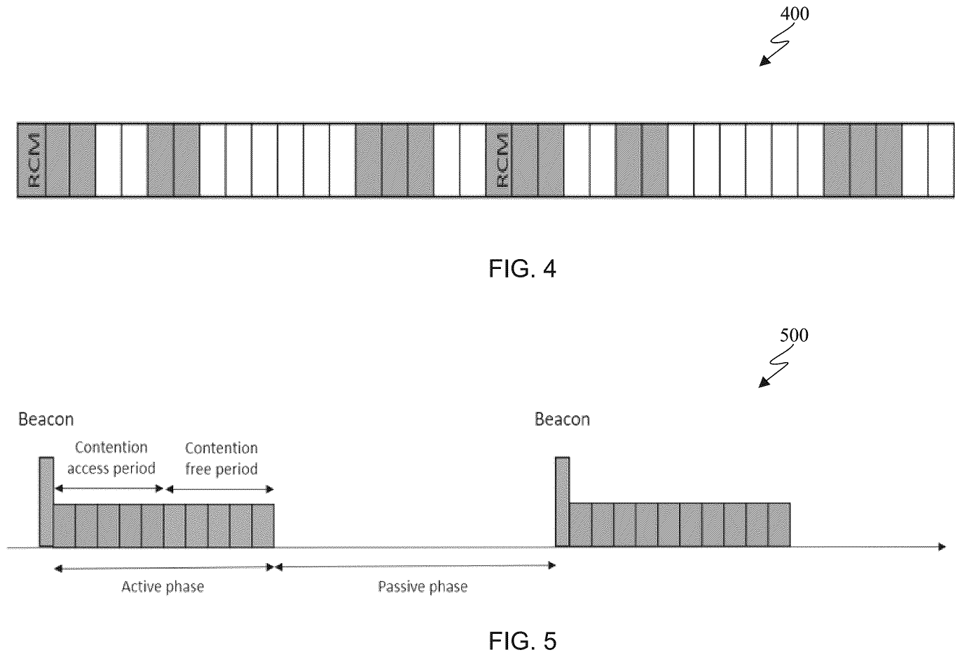

FIG. 4 illustrates an example of a ranging round 400 according to embodiments of the present disclosure. The embodiment of the ranging round 400 shown in FIG. 4 is for illustration only. Other embodiments of the ranging round 500 could be used without departing from the scope of this disclosure.

Ultra-Wide Band (UWB) has recently become popular for use cases involving indoor positioning and navigation using the 6 GHz band. The 802.15.4 amendment defines a block-based mode for ranging in which there are ranging blocks which are divided into ranging rounds which are further divided into ranging slots. The number of ranging rounds in a ranging block, the number of ranging slots in a ranging round and the duration of ranging slot are transmitted by the controller in a ranging control message (RCM) to the participant devices. The information can be for a current ranging round and potential subsequent ranging rounds as well. A ranging slot in which the device is expected to be active is referred to as active slots. There can also be inactive and silent periods.

An example ranging round is shown in FIG. 4, where the active slots are shown as shaded and the inactive slots are shown in white.

### Zigbee:

FIG. 5 illustrates an example of a beacon interval 500 according to embodiments of the present disclosure. The embodiment of the beacon interval 500 shown in FIG. 5 is for illustration only. Other embodiments of the beacon interval 500 could be used without departing from the scope of this disclosure.

ZigBee protocol is another technology developed for smart home applications. The protocol operates based on the concept of beacon intervals. The coordinator in a ZigBee operation sends out periodic beacons. Each beacon is followed by the start of an active phase. The beacon announced the duration of the active phase and the time until the next beacon transmission. Each beacon interval thus is divided into two phases-1. active phase which starts right after the beacon; and 2. passive phase for power save. The active phase can be divided into a contention-based period and a contention free period. The duration of each of the phases and the beacon interval can be characterized by aBaseSlotDuration value, macBeaconOrder (BO) and macSuperframeOrder (SO). BO and SO are integer values ranging from 0 to 14. The beacon interval can be computed as aBaseSuperframeDuration*2^{BO} and the active phase can be computed aBaseSuperframeDuration*2^{SO} where aBaseSuperframeDuration=16*aBaseSlotDuration.

An example timeline is as shown in FIG. 5, where the active phase starts right after the beacon and in the illustrated embodiment, the active phase is divided into a contention-based period and a contention free period.

### Primary and Non-Primary Channel:

Under the current wideband channel usage in Wi-Fi, channels are divided into primary and secondary channels. For 802.11 transmission to occur on a wideband, the primary channel must be idle. If the primary channels are busy, the secondary channels cannot be accessed.

### Seamless Roaming:

The goal of seamless roaming is to provide mechanisms for a non-AP MLD to transition from current AP MLD to target AP MLD such that the time during which the connection is lost is minimal. The seamless roaming procedure can enable a non-AP MLD to remain in state 4 while transitioning from the current AP MLD to the target AP MLD.

The roaming procedure can comprise multiple stages. Two of the important stages are a preparation stage and roam execution/transition stage. During the preparation stage, the non-AP MLD can setup links with the target AP MLD and perform context transfer. Following this stage, the non-AP MLD can perform a roam execution/transition procedure by sending a request frame to transition from current AP MLD to target AP MLD. The current AP MLD can process the request frame and send a response frame to the non-AP MLD after the transfer of context is complete.

These procedures can enable the non-AP MLD to seamlessly roam from current to target AP MLD.

### Prioritized EDCA:

Next generation WLANs can have a technique called P-EDCA in which a STA can transmit a defer signal (DS) to reduce contention on the wireless channel from legacy STAs/STAs that don't transmit such a signal. This can open up an enhanced contention period in which STAs that transmitted such a signal can contend and transmit their data before the other devices come out of a defer/NAV state.

### Quality of Service (QoS):

Stream classification services (SCS) was introduced in 802.11aa amendment to improve multimedia streaming performance. In 802.11be amendment, this feature was enhanced to enable a QoS setup with the AP. As a part of the enhancement, a QoS characteristic element can be carried in SCS descriptor in an SCS request frame. The QoS characteristic element can provide an indication of the QoS requirement for a traffic flow that is indicated in the SCS request frame. E.g., delay bound, MSDU delivery requirements. When the AP accepts the SCS request, it is expected to meet these requirements.

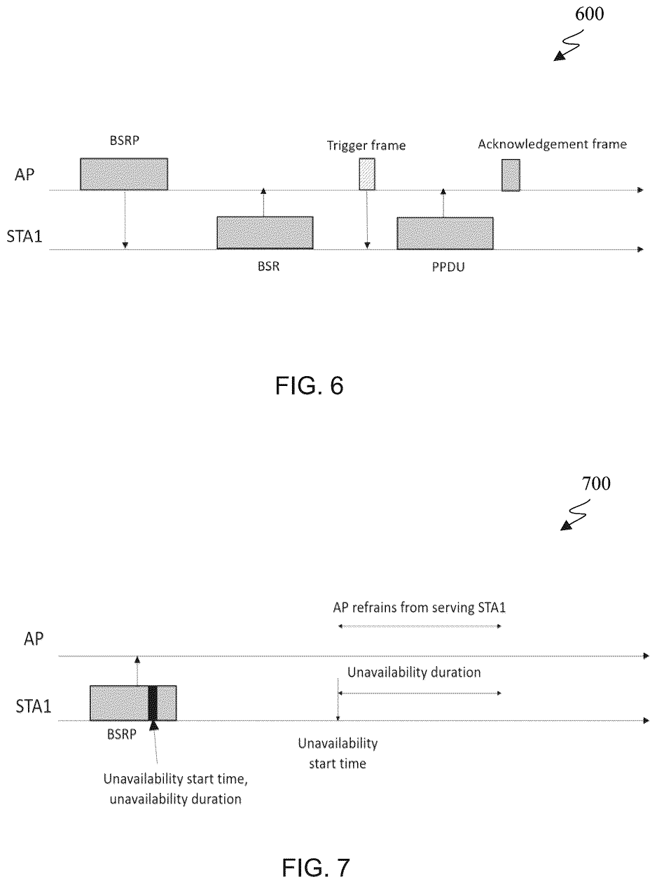

FIG. 6 illustrates an example of a buffer status report poll (BSRP) frame to fetch a buffer status report (BSR) 600 according to embodiments of the present disclosure. The embodiment of the example of a BSRP frame to fetch a BSR 600 shown in FIG. 6 is for illustration only. Other embodiments of the example of a BSRP frame to fetch a BSR 600 could be used without departing from the scope of this disclosure.

Embodiments of the present disclosure recognize that when a STA has to make a dynamic unavailability indication, it can transmit an unsolicited unavailability announcement message to the peer STA to communicate its unavailability constraints (e.g., unavailability start time, unavailability duration, etc.). The unsolicited unavailability announcement message can be a buffer status report (BSRP) trigger frame. However, in legacy systems, the BSRP frame is used to fetch the BSR frame. The AP transmits a BSRP to a STA1 as shown in FIG. 6. STA1 transmits the BSR in response to the BSRP. The AP processes the BSR to fetch the backlog information of STA1. The AP then transmits a trigger to STA1 and fetches the PPDU of STA1.

FIG. 7 illustrates an example of a BSRP frame to report unavailability information 700 according to embodiments of the present disclosure. The embodiment of the example of a BSRP frame to report unavailability information 700 shown in FIG. 7 is for illustration only. Other embodiments of the example of a BSRP frame to report unavailability information 700 could be used without departing from the scope of this disclosure.

Embodiments of the present disclosure recognize that a STA can have a dynamic unavailability operation (DUO) mode setup with the AP. This STA can be also called as a DUO non-AP STA. A DUO non-AP STA that is a TXOP holder can indicate in a BSRP frame to the AP that it is associated with information about the unavailability event i.e., whether it can be unavailable after a specific point in time and if known for how long. Thus, the BSRP frame can carry the start time and duration of the unavailability event. Based on this information, the AP can refrain from scheduling transmissions of any PPDU containing frames addressed to the STA if the PPDU and the solicited PPDU triggered by those frames would overlap with the STA's unavailability time window and if the AP still transmits such a PPDU, the non-AP STA cannot be expected to receive the PPDU. Thus, if the AP transmits PPDUs containing frames addressed to the STA during the STA's unavailability time window, the AP cannot take the failed reception of the transmitted PPDUs for the AP's rate selection algorithm. Further, the AP cannot take the failed reception of the transmitted PPDUs for the AP's EDCA function for the access category (AC) used to transmit these frames. In other words, the STA can be considered to be unavailable. An example can be as shown in FIG. 7.

The BSRP frame transmitted by the STA needs to be processed differently at the AP than how a legacy BSRP frame can be processed. For instance, under a legacy system, the AP can drop/ignore the BSRP frame by considering it as an error some behavior on the STA side as the STA is not expected to fetch BSR from the AP in a legacy system. However, under DUO mode of operation, the BSRP frame can be expected to be processed differently i.e., the AP can be expected to extract the unavailability start time and duration from the frame. Further, the AP can also be expected to have a behavior (described above) during the unavailability event. It is important for the AP side parser to know when to parse a BSRP frame received from the STA to extract the unavailability information and when to drop/ignore it. Further, there can also be a response mechanism for the BSRP frame coming from a DUO non-AP STA. Instead of sending a BSR frame as in the legacy system, the AP can transmit an acknowledgement frame in response.

Consequently, there can be an ambiguity on how to process and respond to a received BSRP trigger frame that is meant to be an unsolicited unavailability announcement frame. A procedure and behavior is needed to address this issue.

Suppose that a STA has setup an unavailability mode (e.g., DUO Mode, PUO Mode). The AP can transmit frames to the STA when the STA can be unavailable. For example, the STA was unable to send a Multi-STA block ACK with unavailability feedback and so the AP can be unaware of the STA's unavailability. In such as case, the behavior of the EDCA operation at the AP side needs to be clarified. Necessary procedure and behavior is needed.

In DUO mode of operation, when an unavailability report is provided to the AP, it reports unavailability for the link on which the report is provided. However, there can be many scenarios wherein the frequency information such as channel, band, etc. which are affected by the unavailability can be useful on the AP side if reported. Examples can be as follows:

### 1. Seamless Roaming

Suppose a non-AP MLD undergoes a roam from a current AP MLD to a target AP MLD. A STA of the non-AP MLD may have reported an unavailability start time and duration to an AP affiliated with the current AP MLD. However, that unavailability can also apply to a link at the target AP MLD which can operate on a different channel from the current AP MLD's link but the unavailability may apply to both.

### 2. Link Change:

Suppose that a STA undergoes link reconfiguration from link 1 to link 2 of an AP MLD. The unavailability may apply to both the links. However, STA's report can be interpreted by the AP MLD as applying to only link 1.

When a STA supports P-EDCA it can transmit the defer signal when certain conditions can be met. How these conditions can get affected under unavailability mode of operation needs to be clarified.

When a STA supports P-EDCA it can transmit the defer signal when certain criteria can be met. For example, when the retry count exceeds a threshold. Under unavailability conditions can impact these criteria. This can cause an excessive amount of P-EDCA usage and hurt the performance of legacy devices as they will not get access to the wireless medium.

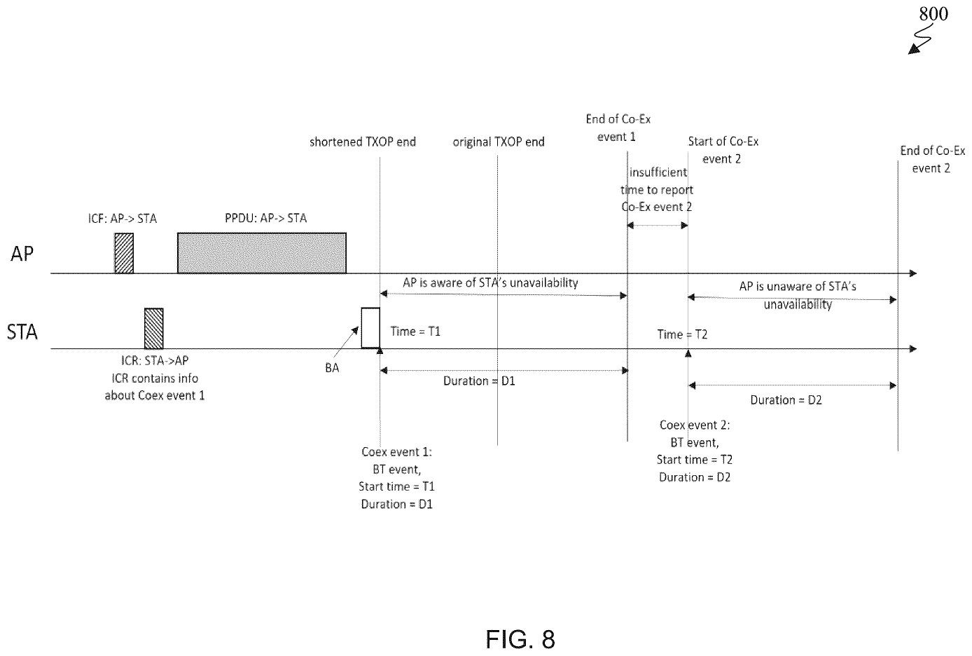

FIG. 8 illustrates an example scenario that illustrates a lack of time to report an upcoming coexistence/unavailability event 800 according to embodiments of the present disclosure. The embodiment of the example scenario that illustrates a lack of time to report an upcoming coexistence/unavailability event 800 shown in FIG. 8 is for illustration only. Other embodiments of the example scenario that illustrates a lack of time to report an upcoming coexistence/unavailability event 800 could be used without departing from the scope of this disclosure.

Currently, the 802.11 specification allows only a single report to be provided to the AP at a time. However, this can be inefficient in a number of scenarios. One example can be where there may not be enough time to report the next unavailability event. An example can is shown in FIG. 8. For such scenarios, it can be important to have the capability to report multiple reports together when possible.

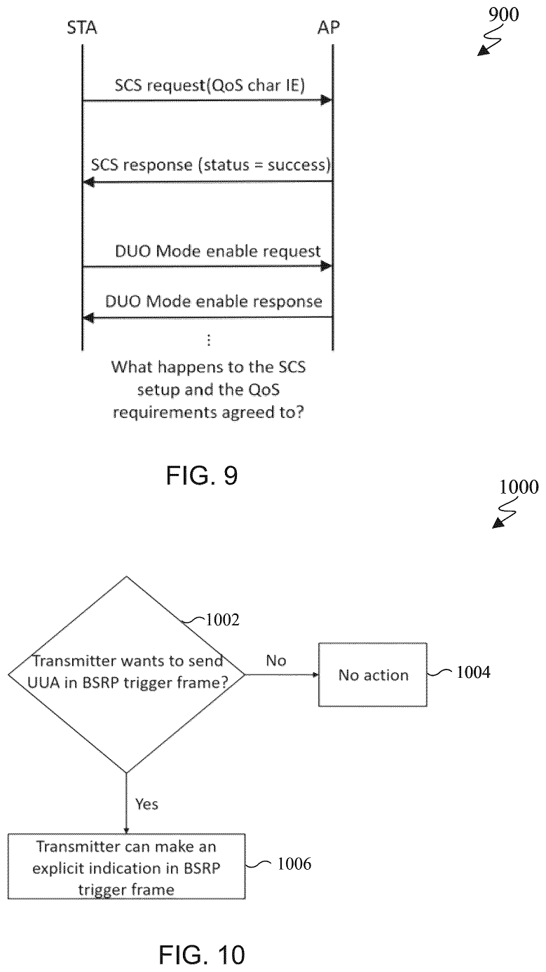

FIG. 9 illustrates an example of quality of service (QoS) setup handling under unavailability mode operation 900 according to embodiments of the present disclosure. The embodiment of the example of quality of service (QoS) setup handling under unavailability mode operation 900 shown in FIG. 9 is for illustration only. Other embodiments of the example of quality of service (QoS) setup handling under unavailability mode operation 900 could be used without departing from the scope of this disclosure.

Suppose that a STA sets up an SCS request and provides a QoS characteristic information element in the SCS request. At a later point in time, the STA also sets up a dynamic unavailability operation (DUO) mode with the AP. In DUO mode, when a STA indicates that it is unavailable for a particular duration of time, the AP should not schedule for transmission PPDUs containing frames addressed to the STA that overlap with its unavailability period of time and if the AP still transmits, the STA is not expected to receive the PPDUs. However, the treatment of a previously setup SCS in the context of this behavior is unclear. This is illustrated in FIG. 9. Procedures and behaviors to address this situation are needed.

Accordingly, embodiments of the present disclosure provide a number of solutions for handling a response procedure for an unsolicited unavailability announcement, including (i) an explicit response indication in the unsolicited unavailability announcement (UUA), and (ii) an implicit response indication in the unsolicited unavailability announcement.

Further, embodiments of the present disclosure provide a number of solutions for handling EDCA parameters under an unavailability mode of operation, including (i) frame handling behavior, (ii) retry/retransmission counter handling, and (iii) contention window growth behavior.

Further still, embodiments of the present disclosure provide a number of solutions for handling frequency information for DUO mode reporting, including (i) frequency information reporting, (ii) example signaling, and (iii) capability advertisement.

Further, embodiments of the present disclosure provide a number of solutions for handling PEDCA behavior under an unavailability operation, including (i) retry count handling, (ii) clearing the buffer before unavailability starts, and (iii) ineligibility to participate in PEDCA.

Further still, embodiments of the present disclosure provide a number of solutions for handling multiple unavailability event reporting, including (i) multiple unavailability event reporting, and (ii) example signaling.

Further, embodiments of the present disclosure provide a number of solutions for handling QoS under an unavailability mode of operation, including (i) update of the SCS agreement, (ii) abiding by the original QoS agreement, and (iii) a best effort QoS agreement.

a. Unsolicited Unavailability Indication Handling

The STA in this disclosure can be a DUO non-AP STA.

### 1. Explicit Response Indication in Unsolicited Unavailability Announcement (UUA)

FIG. 10 illustrates an example of a procedure 1000 for a response indication at the transmitter side according to embodiments of the present disclosure. The embodiment of the example procedure 1000 for a response indication at the transmitter side shown in FIG. 10 is for illustration only. Other embodiments of the example procedure 1000 for a response indication at the transmitter side could be used without departing from the scope of this disclosure.

As shown in FIG. 10, the procedure 1000 begins at step 1002, where a determination is made whether the transmitter wants to send a UUA in a BSRP trigger frame. If the transmitter does not want to send the UUA in a BSRP trigger frame, then at step 1004, no action is taken. If the transmitter wants to send the UUA in a BSRP trigger frame, then at step 1006, the transmitter can make an explicit indication in the BSRP trigger frame.

According to one embodiment, the UUA frame can contain an explicit indication that it is intended for UUA purposes. As an example, the indication can be provided via one or more of the information items indicated in Table 1.

TABLE 1
Explicit response indication

| Information | |
|---|---|
| item | Description |
| Bit based | Addition of a new bit or use of an existing bit (e.g., a |
| indication | reserved bit) to make the indication. For example, a |
| | reserved bit can be set to 1 to make the indication and to 0 |
| | to indicate otherwise. |
| Value based | Addition of a new field or use of an existing field to make |
| indication | the indication. For example, a field that can take a specific |
| | value to make the indication and to another value to |
| | indicate otherwise. |
| Trigger type | Indication via the trigger type. For example, the trigger type |
| indication | subfield can take a new value to make the indication. |

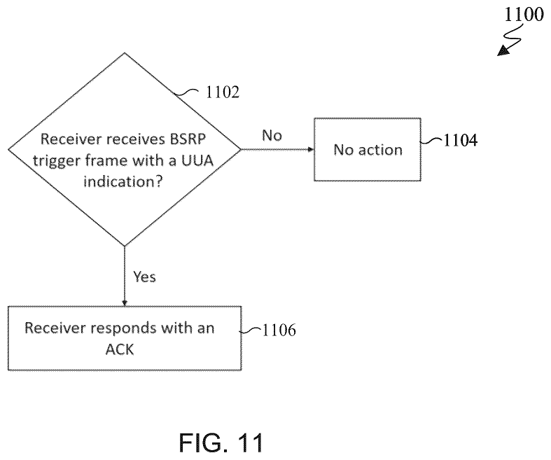

FIG. 11 illustrates an example of a procedure 1100 for a response indication at the receiver side according to embodiments of the present disclosure. The embodiment of the example procedure 1100 for a response indication at the receiver side shown in FIG. 11 is for illustration only. Other embodiments of the example procedure 1100 for a response indication at the receiver side could be used without departing from the scope of this disclosure.

As shown in FIG. 11, the procedure 1100 begins at step 1102, where a determination is made whether the receiver receives a BSRP trigger frame with a UUA indication. If the receiver does not receive a BSRP trigger frame with a UUA indication, then at step 1104, no action is taken. If the receiver does receive a BSRP trigger frame with a UUA indication, then at step 1106, the receiver can respond with an ACK.

When a receiver receives a BSRP trigger frame that contains an indication that it is meant to be a UUA, it can respond with the corresponding response frame (e.g., ACK). Alternatively, the indication can also convey what the response type should be and the receiver can respond with the corresponding response frame.

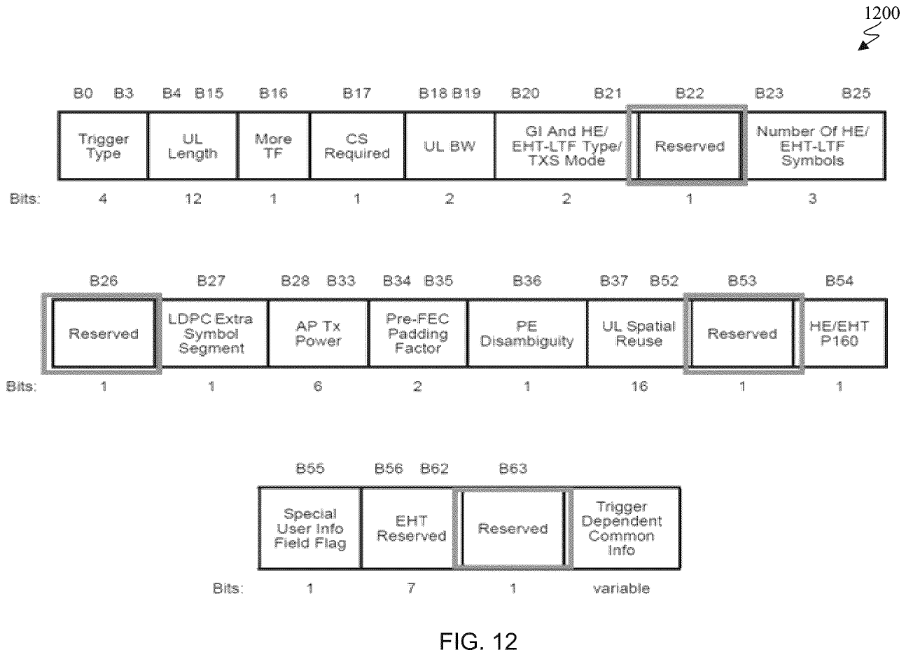

FIG. 12 illustrates example signaling using common field information 1200 according to embodiments of the present disclosure. The embodiment of the example signaling using common field information 1200 shown in FIG. 12 is for illustration only. Other embodiments of the example signaling using common field information 1200 could be used without departing from the scope of this disclosure.

As shown in FIG. 12, in one example, one or more of the reserved bits in the common info field can take specific values to make the indication. The indication can be made by using a single bit or by using a combination of bits.

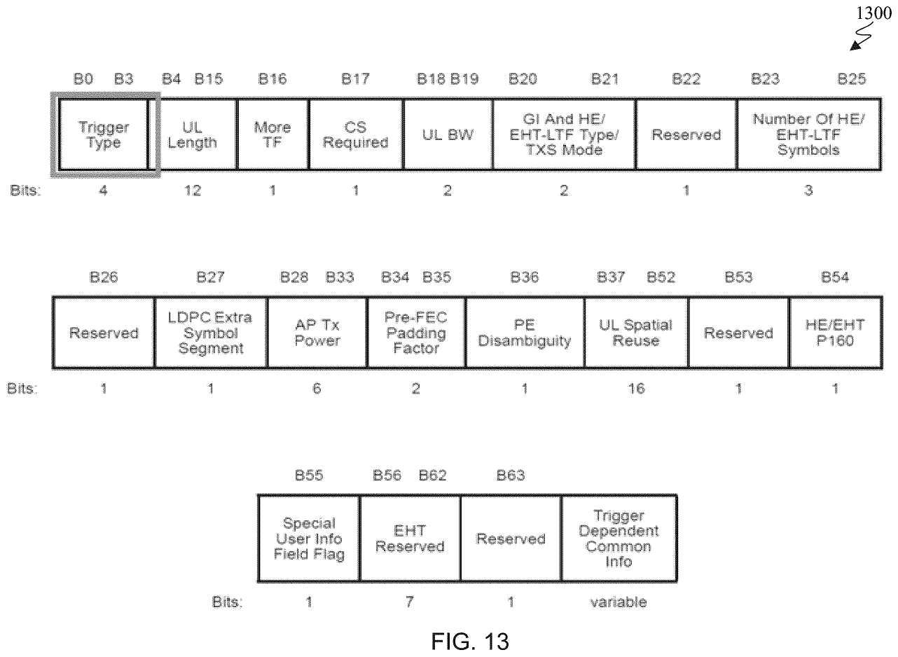

FIG. 13 illustrates example signaling based on a trigger type subfield 1300 according to embodiments of the present disclosure. The embodiment of the example signaling based on a trigger type subfield 1300 shown in FIG. 13 is for illustration only. Other embodiments of the example signaling based on a trigger type subfield 1300 could be used without departing from the scope of this disclosure.

As shown in FIG. 13, in one example, the trigger type subfield can take a value that makes the indication. An example of trigger type subfield encoding is shown in Table 2.

TABLE 2
Trigger type subfield encoding

| Trigger Type subfield value | Trigger frame variant |
|---|---|
| 0 | Basic |
| 1 | Beamforming Report Poll (BFRP) |
| 2 | MU-BAR |
| 3 | MU-RTS |
| 4 | Buffer Status Report Poll (BSRP) |
| 5 | GCR MU-BAR |
| 6 | Bandwidth Query Report Poll (BQRP) |
| 7 | NDP Feedback Report Poll (NFRP) |
| 8 | UUA |
| 9-15 | Reserved |

In another example, the BSRP frame can be an individually addressed frame (e.g., addressed to the AP). The GI and UHR-LTF Type field (a UHR variant of the GI and HE/EHT-LTF Type field shown in FIG. 7) can be equal to a predetermined value (e.g., 3). The UHR variant fields UHR-LTF symbols (a UHR variant of the EHT-LTF Symbols in FIG. 13), the LDPC Extra Symbol Segment field, the AP Tx Power field, the Pre-FEC Padding Factor field, the PE Disambiguity field, the UL Spatial Reuse field, the UHR P160 field, and DRU/RRU Indication field of the Common Info field can be reserved. The Special User Info Flag field of the UHR variant Common Info field can be set to 0, indicating that a Special User Info field is present in the Trigger frame that contains the UHR variant Common Info field. The PHY Version Identifier field of the Special User Info field can be equal to 1, the UHR Spatial Reuse 1 field, the UHR Spatial Reuse 2 field and the U-SIG Disregard And

The Validate field of the Special User Info field can be reserved. In the User Info field with the AID12 field set to the STA's AID, all the other fields of this User Info field can be reserved.

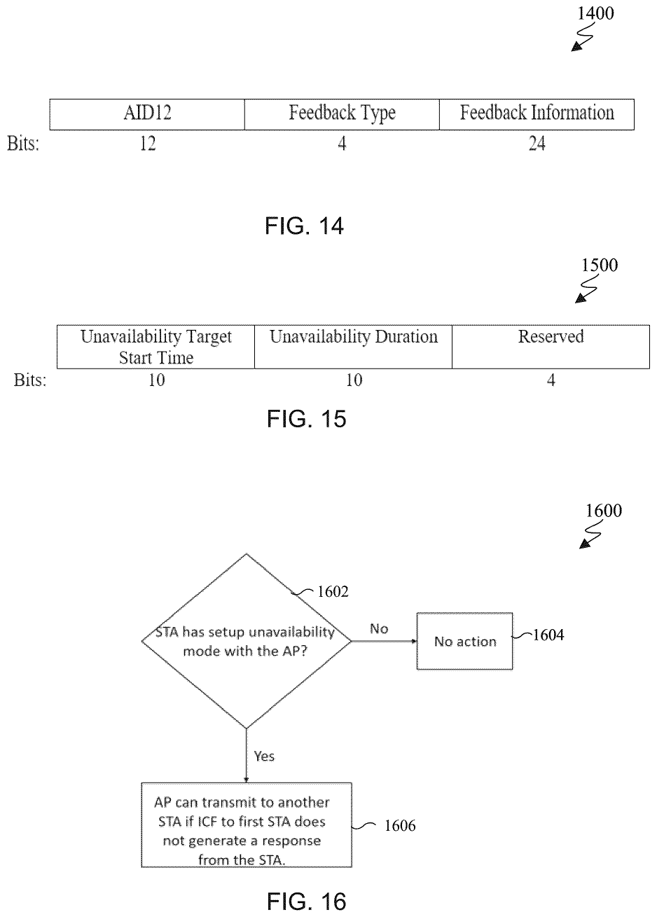

FIG. 14 illustrates an example format of a feedback user information field 1400 according to embodiments of the present disclosure. The embodiment of the example format of a feedback user information field 1400 shown in FIG. 14 is for illustration only. Other embodiments of the example format of a feedback user information field 1400 could be used without departing from the scope of this disclosure.

The AP can fetch a feedback user info field from the user info field of such a BSRP frame. This feedback field can contain the unavailability event information instead of any user specific information. The AID12 value of the feedback user info field can take a predetermined value (e.g., 2008). The feedback user info field can have a format as shown in FIG. 14.

FIG. 15 illustrates an example format of information in the feedback information subfield 1500 according to embodiments of the present disclosure. The embodiment of the example format of information in the feedback information subfield 1500 shown in FIG. 15 is for illustration only. Other embodiments of the example format of information in the feedback information subfield 1500 could be used without departing from the scope of this disclosure.

The feedback type can take a predetermined value to indicate that the BSRP trigger frame can carry unavailability information and can have a format as shown in FIG. 15.

The AP can interpret the unavailability target start time of the BSRP frame as carrying the value of TSF (15:6) of the time when the STA transmitting the frame can become unavailable. The field can be reserved and ignored by the AP if the unavailability duration field is equal to 0. The unavailability duration field can be interpreted to indicate the duration in the units of 64 microseconds over which the STA that transmitted the BSRP frame can be unavailable. A value of 0 can indicate that the STA can be available and a value of 1023 can indicate that the STA can be available for an indefinite duration of time.

After fetching the unavailability start time and duration, the AP can react as described previously.

### 2. Implicit Response Indication in Unsolicited Unavailability Announcement

According to one embodiment, there can be an implicit indication in the UUA. The implicit indication can be made based on one or more methods indicated below.

### 2.a Values of Certain Field in the UUA

According to one embodiment, when a BSRP trigger frame is used as a UUA and is expecting an ACK in return, it can set the UL length in the common info field to the value that is equal to that of the UL length for an ACK. When a receiver receives a UUA with the UL length set to indicate an ACK response, it can transmit an ACK as a response frame. It can also process the BSRP frame to extract the unavailability event information and react as described previously.

According to one embodiment, when a BSRP trigger frame is used as a UUA and is expecting an ACK frame, it can set the value of CS required field to indicate an ACK is expected in response.

### 2.b1 Type of Transmitter

According to one embodiment, if the transmitter of the BSRP trigger frame is a DUO non-AP STA and the receiver is the AP, then the response frame can be an ACK. For such a BSRP frame, the AP can fetch the unavailability event information as described previously.

According to one embodiment, if the transmitter of the BSRP trigger frame is an AP, then the response frame can be BSR/M-STA BA.

### 2.b2 STA is in Co-Ex Mode

According to one embodiment, if the BSRP trigger frame is received from a STA that is in Co-Ex/DUO mode, then the response frame can be an ACK.

### 2.c Presence of Co-Ex Report

According to one embodiment, if the BSRP trigger frame contains a Co-Ex report, then the receiver can respond with an ACK.

According to one embodiment, the BSR frame can be transmitted in place of an ACK.

According to one embodiment, M-STA BA can be transmitted in place of an ACK.

Receipt of either of these two frames can be considered as an indication of acknowledgement of the Co-Ex report in the UUA.

### B. Edca Management Under Unavailability Operation

### 1. Frame Handling Behavior

FIG. 16 illustrates an example of a frame handling procedure 1600 according to embodiments of the present disclosure. The embodiment of the example of a frame handling procedure 1600 shown in FIG. 16 is for illustration only. Other embodiments of the example of a frame handling procedure 1600 could be used without departing from the scope of this disclosure.

As shown in FIG. 16, the procedure 1600 begins at step 1602, where a determination is made whether the STA has setup an unavailability mode with the AP. If the STA has not setup an unavailability mode with the AP, then at step 1604, no action is taken. If the STA has setup an unavailability mode with the AP, then at step 1606, the AP can transmit to another STA if the ICF to the first STA does not generate a response from the STA.

According to one embodiment, when an ICF is transmitted to a STA that has setup an unavailability mode with the AP and the STA does not respond back, the AP can use that TXOP to serve another STA whose packets are in the queue. The AP can serve the first STA at a later point in time. Thus, the AP can keep the STA's frame for future attempts and the scheduling may not be FIFO.

According to another embodiment, the AP can use a different TXOP limit (shorter TXOP limit) until the STA responds back with an ICF and switch to a longer TXOP limit thereafter.

### 2. Retry/Retransmission Counter Handling

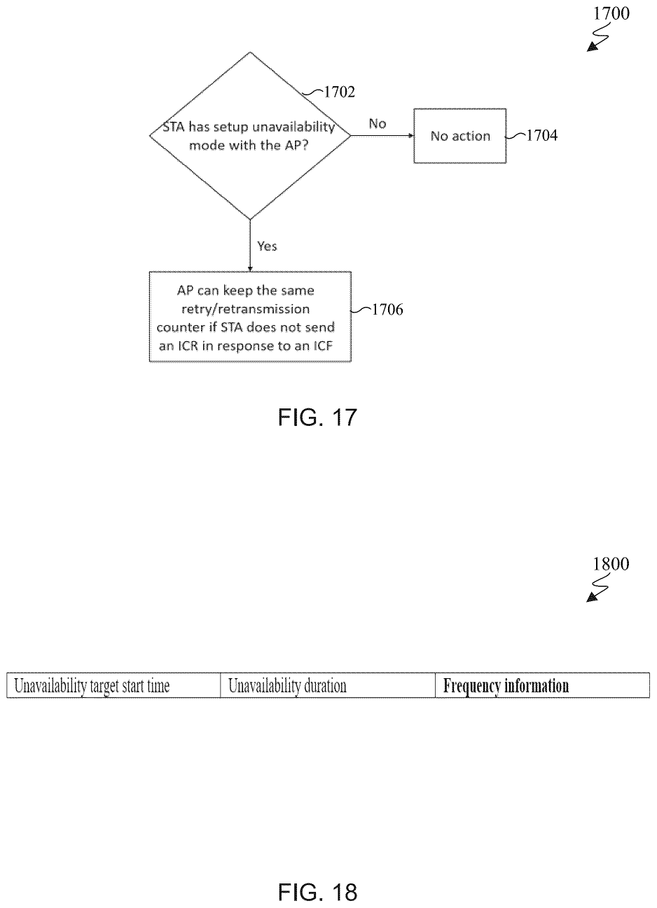

FIG. 17 illustrates an example procedure for retry/retransmission counter handling 1700 according to embodiments of the present disclosure. The embodiment of the example procedure for retry/retransmission counter handling 1700 shown in FIG. 17 is for illustration only. Other embodiments of the example procedure for retry/retransmission counter handling 1700 could be used without departing from the scope of this disclosure.

As shown in FIG. 17, the procedure 1700 begins at step 1702, where a determination is made whether the STA has setup an unavailability mode with the AP. If the STA has not setup an unavailability mode with the AP, then at step 1704, no action is taken. If the STA has setup an unavailability mode with the AP, then at step 1706, the AP can keep the same retry/retransmission counter if the STA does not send an ICR in response to an ICF.

According to one embodiment, when an ICF is transmitted to a STA that has setup an unavailability mode with the AP and the STA does not respond back, the AP can keep the same retry counter value for the frame and not increment it. Thus, the AP may not drop the frame due to multiple failed ICF attempts. Thus, the frame of the STA won't be dropped in the case where the AP makes multiple failed attempts to it.

According to another embodiment, the AP can use a different threshold for maximum retry/retransmission count (different from the one used for legacy) for a frame that belongs to a STA that has setup an unavailability mode with the AP. The threshold can be advertised by the AP in one or more frames that it transmits. For example, management frames such as beacons, probe responses, etc.

### 3. Contention Window Growth Behavior

According to one embodiment, when an ICF is transmitted to a STA that has setup an unavailability mode with the AP and the STA does not respond back, the AP can keep the same contention widow for the next attempt if it chooses to do so.

According to another embodiment, the AP can double the contention window size in the first failed attempt but maintain the same contention window size for all successive attempts.

### C. Frequency Related Information Sharing Under Dynamic

### Unavailability Operation

### 1. Frequency Information Reporting

According to one embodiment, the information reported can comprise at least one or more of the following information items in Table 3.

TABLE 3
Information items related to frequency info

| Information | |
|---|---|
| item | Description |
| Band | One or more information items that can describe the band(s) |
| information | affected by the unavailability. |
| Channel | One or more information items that can describe the |
| information | channels affected by the unavailability. |
| Resource | One or more information items that can describe the |
| units | resource units affected by the unavailability. |

### 1. Example Signaling

a. Indication in DUO Mode Enablement Frame

In one embodiment, information indication can be in a DUO mode enablement frame as shown in Table 4.

TABLE 4
Modified DUO Mode enablement frame

| Order | Information |
|---|---|
| 1 | Category |
| 2 | Protected UHR Action |
| 3 | Dialog Token |
| 4 | UHR Control |
| 5 | DUO frequency information |

The order can be different than that shown in this example.

Thus, at the time of setup the frequency information can be provided and it can apply to all ICRs sent after DUO is enabled.

### 2.2 Indication in Feedback Subfield

FIG. 18 illustrates an example of a format for a feedback subfield 1800 according to embodiments of the present disclosure. The embodiment of the example format for a feedback subfield 1800 shown in FIG. 18 is for illustration only. Other embodiments of the example format for a feedback subfield 1800 could be used without departing from the scope of this disclosure.

As shown in FIG. 18, according to one embodiment, a multi-STA block ACK can carry a feedback subfield that has the frequency information present in it. Thus, the AP can know the band/channel, etc. that can be affected by the unavailability event.

### 3. Capability Advertisement

An AP and a STA that support such a capability can advertise the support in one or more frames that they advertise, for example in management frames.

### D. Prioritized Edca Operation Under Unavailability Mode in Next Generation WLANS

### 1. Retry Count Handling

In some embodiments, when a STA has enabled an unavailability mode (e.g., DUO, PUO etc.), a second STA transmitting frames to it can keep the PEDCA retry counter the same every time it fails to receive an ICR from the STA.

### 2. Clearing the Buffer Before Unavailability Starts

In anticipation of an unavailability duration that can increase delays to already buffered frames, a STA can initiate a PEDCA and transmit a defer signal to gain channel access and aggressively clear its buffer before the unavailability duration start.

### 3. Ineligibility to Participate in PEDCA

According to one embodiment, when a STA has setup an unavailability mode, the other STA transmitting to it cannot qualify for PEDCA based transmission.

### E. Feedback Procedure for Multiple Unavailability Event Reporting in Next Generation WLANS

### 1. Multiple Unavailability Event Reporting

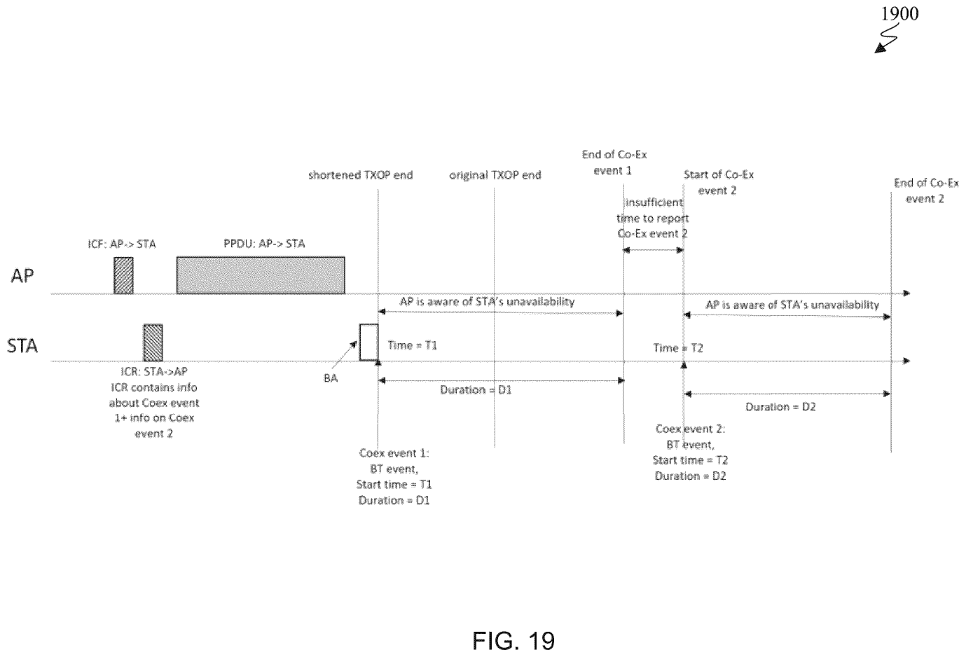

FIG. 19 illustrates an example scenario that illustrates multiple unavailability event reporting 1900 according to embodiments of the present disclosure. The embodiment of the example scenario that illustrates multiple unavailability event reporting 1900 shown in FIG. 19 is for illustration only. Other embodiments of the example scenario that illustrates multiple unavailability event reporting 1900 could be used without departing from the scope of this disclosure.

According to one embodiment, the STA can report multiple unavailability events together. According to this embodiment, the ICR can contain a report of more than one unavailability event. An example can be as shown in FIG. 19.

### 2. Example Signaling

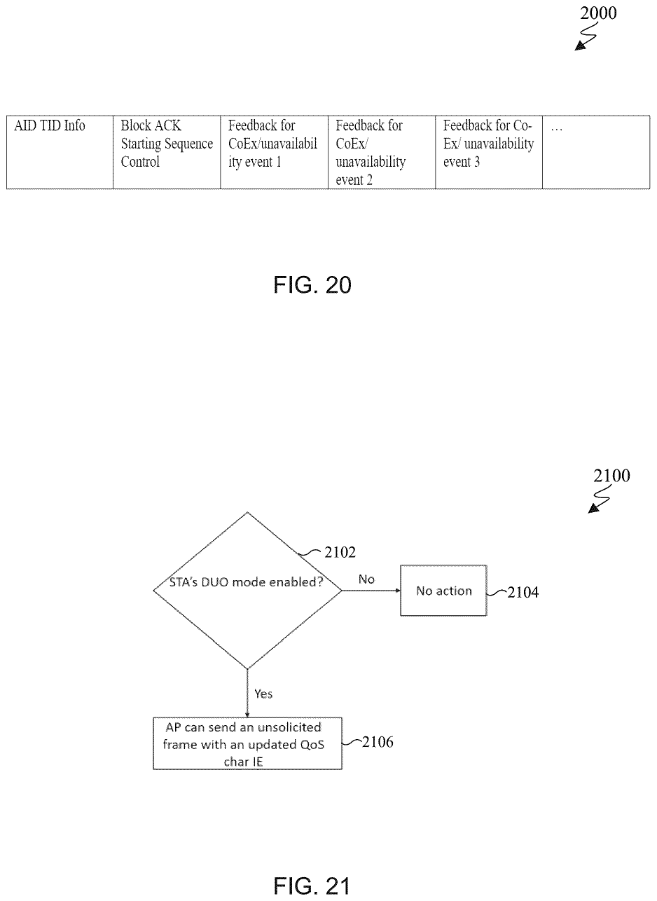

FIG. 20 illustrates an example of a format for multiple feedback subfields in the per application ID (AID) traffic identified (TID) information field 2000 according to embodiments of the present disclosure. The embodiment of the example format for multiple feedback subfields in the per application ID (AID) traffic identified (TID) information field 2000 shown in FIG. 20 is for illustration only. Other embodiments of the example for multiple feedback subfields in the per application ID (AID) traffic identified (TID) information field 2000 could be used without departing from the scope of this disclosure.

According to one embodiment, the Per AID TID Info field in the multi-STA block ACK variant can contain multiple feedback subfields as indicated in FIG. 20.

If two or more Co-Ex/unavailability events have the same start time or an overlap in the unavailability duration, they can be merged into a single report.

When the multi-STA Block ACK variant contains multiple feedback, there can be a count field that can indicate how many feedback subfields are included.

There can also be an indication of what type of feedback are present when multiple feedback subfields are present.

According to another embodiment, each Co-Ex or unavailability report can be transmitted as a separate Per AID TID Info field.

### F. Qos Setup Handling Under Unavailability Mode Operation

### 1. Update of SCS Agreement

FIG. 21 illustrates an example procedure 2100 of an update of a stream classification service (SCS) agreement according to embodiments of the present disclosure. The embodiment of the example procedure 2100 of an update of an SCS agreement shown in FIG. 21 is for illustration only. Other embodiments of the example procedure 2100 of an update of an SCS agreement could be used without departing from the scope of this disclosure.

As shown in FIG. 21, the procedure 2100 begins at step 2102, where a determination is made whether the STA's DUO mode is enabled. If the STA's DUO mode is not enabled, then at step 2104, no action is taken. If the STA's DUO mode is enabled, then at step 2106, the AP can send an unsolicited frame with an updated QoS information element.

According to one embodiment, when a STA sets up a DUO mode with the AP, the AP can provide an unsolicited SCS response frame to the STA. The STA response frame can contain updated QoS metrics (e.g., delay bounds, MSDU delivery information, etc.) that the AP can meet given the STA's newly setup DUO mode.

### 2. Abiding by the Original SCS Agreement

According to one embodiment, the AP can abide by the original SCS agreement even if the STA has setup a DUO mode with the AP.

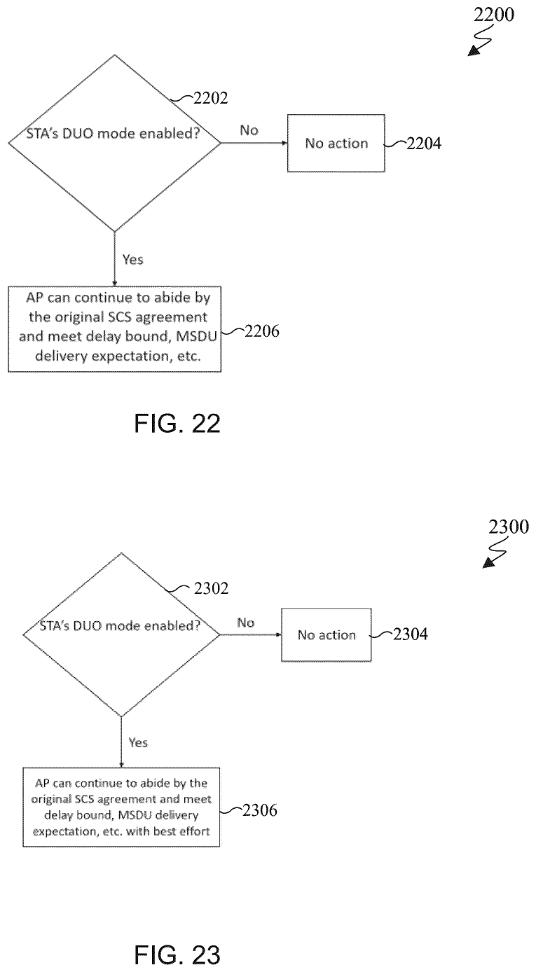

FIG. 22 illustrates an example procedure 2200 of abiding by the original SCS agreement according to embodiments of the present disclosure. The embodiment of the example procedure 2200 of abiding by the original SCS agreement shown in FIG. 22 is for illustration only. Other embodiments of the example procedure 2200 of abiding by the original SCS agreement could be used without departing from the scope of this disclosure.

As shown in FIG. 22, the procedure 2200 begins at step 2202, where a determination is made whether the STA's DUO mode is enabled. If the STA's DUO mode is not enabled, then at step 2204, no action is taken. If the STA's DUO mode is enabled, then at step 2206, the AP can continue to abide by the original SCS agreement and meet delay bound, MDSU delivery expectation, etc.

### 3. Best Effort QoS Handling

FIG. 23 illustrates an example procedure 2300 for quality of service (QoS) handling according to embodiments of the present disclosure. The embodiment of the example procedure 2300 for quality of service (QoS) handling shown in FIG. 23 is for illustration only. Other embodiments of the example procedure 2300 for quality of service (QoS) handling could be used without departing from the scope of this disclosure.

As shown in FIG. 23, the procedure 2300 begins at step 2302, where a determination is made whether the STA's DUO mode is enabled. If the STA's DUO mode is not enabled, then at step 2304, no action is taken. If the STA's DUO mode is enabled, then at step 2306, the AP can continue to abide by the original SCS agreement and meet delay bound, MDSU delivery expectation, etc. with best effort.

According to one embodiment, when a STA sets up a DUO mode with the AP, there can be an understanding on the STA side that the AP may not be able to meet the SCS agreement with respect to QoS requirements of the STA's traffic in light of the DUO mode of operation.

The above embodiments can also apply to periodic unavailability operation mode.

The acknowledgement frame (ACK) mentioned herein can be a Multi-STA BlockAck frame. The multi-STA BlockAck frame can carry an encoding indicating that it is a response frame to a BSRP frame (e.g., a Per AID TID Info field with the Ack Type field set to 1 and the TID subfield set to 13).

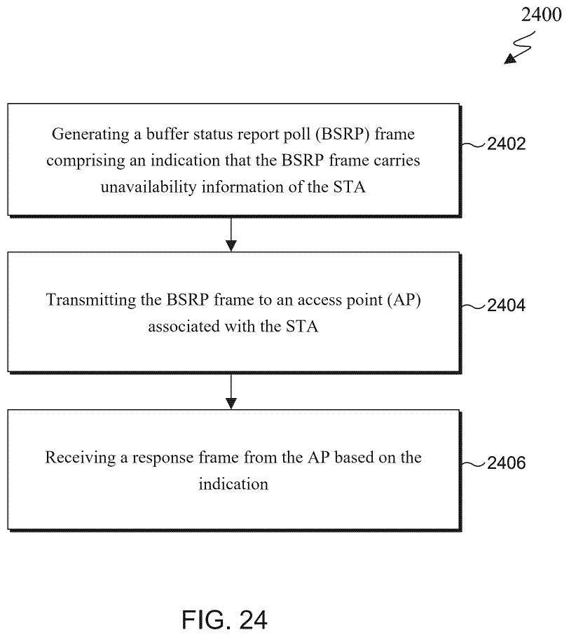

FIG. 24 illustrates an example method 2400 performed by a STA in a wireless communication system according to embodiments of the present disclosure. The method 2400 of FIG. 24 can be performed by any of the STAs 111-114 of FIG. 1, such as the STA 111 of FIG. 3, and a corresponding method can be performed by any of the APs 101-103 of FIG. 1, such as AP 101 of FIG. 2. The method 2400 is for illustration only and other embodiments can be used without departing from the scope of the present disclosure.

As illustrated in FIG. 24, the method 2400 begins at step 2402, where the STA generates a buffer status report poll (BSRP) frame comprising an indication that the BSRP frame carries unavailability information of the STA. At step 2404, the STA transmits the BSRP frame to an access point (AP) associated with the STA. At step 2406, the STA receives a response frame from the AP based on the indication.

In some embodiments, the indication comprises an explicit indication that the BSRP frame carries the unavailability information.

In some embodiments, the explicit indication comprises one or more bits, or one or more reserved bits in a common information field in the BSRP frame; and the response frame comprises an acknowledgement frame.

In some embodiments, the explicit indication comprises a value in a trigger type subfield in the BSRP frame; and the response frame comprises an acknowledgement frame.

In some embodiments, the BSRP frame comprises an individually addressed frame that is addressed to the AP; the explicit indication comprises a value in a common information field in the individually addressed frame; and the response frame comprises an acknowledgement frame.

In some embodiments, the indication comprises an implicit indication that the BSRP frame carries the unavailability information.

In some embodiments, the implicit indication comprises a value in one or more fields in the BSRP frame; and the response frame comprises an acknowledgement frame.

In some embodiments, the implicit indication comprises a coexistence report in the BSRP frame; and the response frame comprises an acknowledgement frame.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A station (STA) comprising:
a transceiver; and
a processor operably coupled with the transceiver, the processor configured to:
generate a buffer status report poll (BSRP) frame comprising an indication that the BSRP frame carries unavailability information of the STA;
transmit, via the transceiver, the BSRP frame to an access point (AP) associated with the STA; and
receive, via the transceiver, a response frame from the AP based on the indication.

2. The STA of claim 1, wherein the indication comprises an explicit indication that the BSRP frame carries the unavailability information.

3. The STA of claim 2, wherein:
the explicit indication comprises one or more bits, or one or more reserved bits in a common information field in the BSRP frame; and
the response frame comprises an acknowledgement frame.

4. The STA of claim 2, wherein:
the explicit indication comprises a value in a trigger type subfield in the BSRP frame; and
the response frame comprises an acknowledgement frame.

5. The STA of claim 2, wherein:
the BSRP frame comprises an individually addressed frame that is addressed to the AP;
the explicit indication comprises a value in a common information field in the individually addressed frame; and
the response frame comprises an acknowledgement frame.

6. The STA of claim 1, wherein the indication comprises an implicit indication that the BSRP frame carries the unavailability information.

7. The STA of claim 6, wherein:
the implicit indication comprises a value in one or more fields in the BSRP frame; and
the response frame comprises an acknowledgement frame.

8. TA of claim 6, wherein:
the implicit indication comprises a coexistence report in the BSRP frame; and
the response frame comprises an acknowledgement frame.

9. An access point (AP) comprising:
a transceiver; and
a processor operably coupled with the transceiver, the processor configured to:
receive from a station (STA) associated with the AP, via the transceiver, a buffer status report poll (BSRP) frame comprising an indication that the BSRP frame carries unavailability information of the STA; and
transmit, via the transceiver, a response frame to the STA based on the indication.

10. The AP of claim 9, wherein the indication comprises an explicit indication that the BSRP frame carries the unavailability information.

11. The AP of claim 10, wherein:
the explicit indication comprises:
one or more bits, or one or more reserved bits in a common information field in the BSRP frame; or
a value in a trigger type subfield in the BSRP frame; and
the response frame comprises an acknowledgement frame.

12. The AP of claim 9, wherein the indication comprises an implicit indication that the BSRP frame carries the unavailability information.

13. The AP of claim 12, wherein:
the implicit indication comprises:
a value in one or more fields in the BSRP frame; or
a coexistence report in the BSRP frame; and
the response frame comprises an acknowledgement frame.

14. A method performed by a station (STA), the method comprising:
generating a buffer status report poll (BSRP) frame comprising an indication that the BSRP frame carries unavailability information of the STA;
transmitting the BSRP frame to an access point (AP) associated with the STA; and
receiving a response frame from the AP based on the indication.

15. The method of claim 14, wherein the indication comprises an explicit indication that the BSRP frame carries the unavailability information.

16. The method of claim 15, wherein:
the explicit indication comprises one or more bits, or one or more reserved bits in a common information field in the BSRP frame; and
the response frame comprises an acknowledgement frame.

17. The method of claim 15, wherein:
the explicit indication comprises a value in a trigger type subfield in the BSRP frame; and
the response frame comprises an acknowledgement frame.

18. The method of claim 15, wherein:
the BSRP frame comprises an individually addressed frame that is addressed to the AP;
the explicit indication comprises a value in a common information field in the individually addressed frame; and
the response frame comprises an acknowledgement frame.

19. The method of claim 14, wherein the indication comprises an implicit indication that the BSRP frame carries the unavailability information.

20. The method of claim 19, wherein:
the implicit indication comprises:
a value in one or more fields in the BSRP frame; or
a coexistence report in the BSRP frame; and
the response frame comprises an acknowledgement frame.
